(19) United States
(12) Patent Application Publication
(10) Pub. No.: US 2013/0021367 A1
(43) Pub. Date: Jan. 24, 2013

(54) METHODS OF CONTROLLING WINDOW DISPLAY ON AN ELECTRONIC DEVICE USING COMBINATIONS OF EVENT GENERATORS

(71) Applicant: Seung-Soo Yang, Hwaseong-si (KR)

(72) Inventor: Seung-Soo Yang, Hwaseong-si (KR)

(73) Assignee: Samsung Electronics Co., Ltd.

(21) Appl. No.: 13/469,387

(22) Filed: May 11, 2012

(30) Foreign Application Priority Data
Jul. 19, 2011 (KR) 10-2011-0071593

(51) Int. Cl. G09G 5/00; G06F 3/041; G06F 3/033

(52) U.S. Cl. 345/619; 345/163; 345/173; 345/156

(57) ABSTRACT

First and second events generated by respective ones of first and second event generators are detected and a particular type of window transformation is executed on a display of an electronic device based on the first event in a direction identified by the second event. The type of window transformation may be, for example, a position change or a size adjustment.

### CROSS-REFERENCE TO RELATED APPLICATIONS

This application claims priority under 35 U.S.C. §119(a) from Korean Patent Application No. 10-2011-0071593 filed on Jul. 19, 2011, the disclosure of which is hereby incorporated by reference in its entirety.

### BACKGROUND

Embodiments of the inventive subject matter relate to graphical user interfaces and, more particularly, to control of window display simply controlling window display.

When a user controls a window displayed on a display of a computer, the user typically needs to put a mouse pointer at a particular area (e.g., a title bar) of the window and drag the mouse pointer in order to change the position of the window. In order to adjust the size of the window, the user may put the mouse pointer at a particular position (e.g., a boundary line) of the window and drag the mouse pointer. However, as a display of a computer system becomes large in size, users may feel very uncomfortable when changing the position or adjusting the size of a window.

Graphical user interface (GUI) layout typically is fixed for conventional smart televisions (TVs) or digital information display (DID) systems. However, as displays increase in size, it is desirable for users to be able to control GUI layout. Conventional mobile devices, such as smart phones and tablet personal computers (PCs), typically do not support position GUI change and size adjustment, but are typically configured to concurrently operate multiple applications. Mobile devices typically do not use a peripheral user input device, such as a mouse, so it may not be possible to control, for example, a window using techniques used in computers.

### SUMMARY

Some embodiments of the inventive subject matter provide methods of operating an electronic device including a display. The methods include detecting first and second events generated by respective ones of first and second event generators and executing a particular type of window transformation on the display based on the first event in a direction identified by the second event. The type of window transformation may be, for example, a position change or a size adjustment.

In some embodiments, the first event generator may be a keyboard including a plurality of keys and the first event may be generated by pressing down one of the keys. The second event generator may be a mouse including a plurality of buttons and the second event may be generated by dragging the mouse with one of the buttons pressed.

In further embodiments, the first event generator may be one of a plurality of buttons implemented in a non-display area of a mobile device, and the first event may be generated by pressing down the one of the plurality of buttons. The second event generator may be a display area of a mobile device and the second event may be generated by touching the display area. The type of window transformation may be based on a number of touch points made by a user on the display area.

In still further embodiments, the first event generator may be one of a plurality of buttons implemented in a non-display area of a mobile device and the first event may be generated by pressing one of the buttons. The second event generator may be an acceleration sensor of the mobile device and the second event may be generated responsive to an input to the acceleration sensor.

In additional embodiments, the first event generator may be an ambient light sensor of a mobile device and the first event may be generated by covering the ambient light sensor. The second event generator may be an acceleration sensor of the mobile device and the second event may be generated responsive to an input to the acceleration sensor.

In still further embodiments, the first event generator may one of a plurality of buttons of a remote control device and the first event may be generated by pressing the one of the buttons. The second event generator may be an acceleration sensor of the remote control device and the second event may be generated responsive to an input to the acceleration sensor.

Additional embodiments provide methods of operating an electronic device including a display, the methods including sensing a touch on a touch screen associated with the display, comparing a duration of the touch with a reference time and controlling the window according to a drag direction of the touch when the duration meets a predetermined criterion with respect to the reference time. The type of window transformation may be, for example, a position change or a size adjustment. The type of window transformation may be determined based on a number of points of the sensed touch. The, type of window transformation based on the duration of the touch.

Still further embodiments provide methods of controlling a window on a display of an electronic device in which a first user input of a first type is accepted and a window transformation operation is identified based on the first user input. A second user input of a second type is accepted and the identified window transformation operation is performed in a direction indicated by the second user input. The window transformation operation may include a window repositioning or a window resizing operation.

In some embodiments, the first type may include a button actuation, a mouse selection or a touch screen selection. The second type may include an acceleration sensor input, a mouse movement or touch screen swipe.

In some embodiments, the electronic device may be a handheld mobile device. The first user input may include activation of a button on the mobile device and the second user input may include an input to an accelerometer of the mobile device or an input to a touch screen of the mobile device. In some embodiments, the electronic device may be a television, the first user input may include actuation of a button on a remote control device and the second user input may include an input to an accelerometer of the remote control device.

### BRIEF DESCRIPTION OF THE DRAWINGS

The above and other features and advantages of the inventive subject matter will become more apparent by describing in detail exemplary embodiments thereof with reference to the attached drawings in which:

FIG. 1 is a block diagram illustrating operations for controlling a window according to some embodiments of the inventive subject matter;

FIG. 2 is a block diagram of a window control system according to some embodiments of the inventive subject matter;

FIG. 3 is a diagram illustrating operations for controlling a window displayed on a display of a computer according to some embodiments of the inventive subject matter;

FIGS. 4A through 4C are diagrams illustrating operations for controlling the position change of the window displayed for the display of the computer illustrated in FIG. 3 according to some embodiments of the inventive subject matter;

FIGS. 5A through 5C are diagrams illustrating operations for controlling the size adjustment of the window displayed at the display of the computer illustrated in FIG. according to further embodiments of the inventive subject matter;

FIG. 6 is a diagram illustrating operations for controlling a window displayed on a display of a mobile device according to some embodiments of the inventive subject matter;

FIGS. 7A and 7B are diagrams illustrating operations for controlling the position change of a window displayed on a display of a mobile device according to further embodiments of the inventive subject matter;

FIGS. 8A and 8B are diagrams illustrating operations for controlling the size adjustment of a window displayed on a display of a mobile device according to some embodiments of the inventive subject matter;

FIGS. 9A and 9B are diagrams illustrating operations for controlling the size adjustment of a window displayed on a display of a mobile device according to yet further embodiments of the inventive subject matter;

FIGS. 10A and 10B are diagrams illustrating operations for controlling the position change of a window displayed on a display of a mobile device according to still further embodiments of the inventive subject matter;

FIGS. 11A and 11B are diagrams illustrating operations for controlling the position change of a window displayed on a display of a television (TV) according to further embodiments of the inventive subject matter;

FIGS. 12A and 12B are diagrams illustrating operations for controlling the size adjustment of a window displayed on a display of a TV according to some embodiments of the inventive subject matter;

FIG. 13 is a flowchart illustrating operations for controlling a window displayed on a display according to some embodiments of the inventive subject matter;

FIGS. 14A through 14C are diagrams illustrating operations for controlling the position change of a window displayed on a display of a mobile device according to further embodiments of the inventive subject matter;

FIGS. 15A through 15C are diagrams illustrating operations for controlling the size adjustment of a window displayed on a display of a mobile device according to still further embodiments of the inventive subject matter; and

FIG. 16 is a diagram illustrating directions in which the size of a window may be adjusted according to some embodiments of the inventive subject matter.

### DETAILED DESCRIPTION OF THE EMBODIMENTS

The inventive subject matter now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

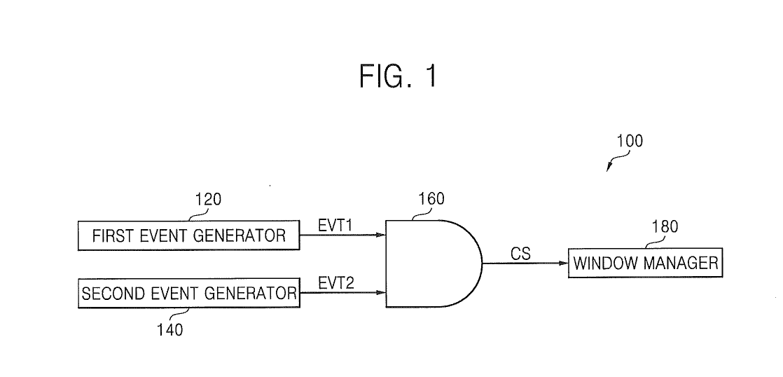

FIG. 1 is a block diagram illustrating operations for controlling a window according to some embodiments of the inventive subject matter. Referring to FIG. 1, a window control system 100 includes a first event generator 120, a second event generator 140, an event manager 160, and a window manager 180.

Referring to FIG. 1, the method may be performed using the first event generator 120, the second event generator 140, the event manager 160, and the window manager 180.

For clarity of the description, only the first and the second event generators 120 and 140 are illustrated in FIG. 1, but the operations may be performed using more than two event generators. Although the first and the second event generators 120 and 140 are illustrated as separate input devices, they may be included in a single input device.

The event manager 160 combines a first event EVT1 generated in the first event generator 120 and a second event EVT1 generated in the second event generator 140 and generate a control signal CS.

The window manager 180 receives the control signal CS from the event manager 160 and controls the window displayed at the display according to the second event EVT2 while the control signal CS is being generated.

Here, the term “manager” may indicate a hardware that can perform functions and operations in accordance with a name, a computer program code that can perform particular functions and operations, or an electronic recording medium, e.g., a processor, equipped with the computer program code that can perform the particular functions and operations. In other words, the “manager” may indicate hardware for carrying out the technical ideas of the inventive subject matter, software for driving the hardware, and/or the functional and/or structural combination of the hardware and the software.

The first event generator 120 may be a keyboard, a pointing device, an image input device, an audio input device, a magnetic proximity sensor, an ambient light sensor, a temperature sensor, or a remote controller.

For instance, a user may input the first event EVT1 through a key input using a keyboard, a button or a motion input using a pointing device, an image or a motion input using an image input device, or au audio input using an audio input device.

The second event generator 140 may be a pointing device such as a mouse, a trackball, a joystick, a pointing stick, a graphics tablet, a touchpad, a touch screen, a light pen, a light gun, a footmouse, an eye tracking device, an acceleration sensor, a gyro sensor, or a geo magnetic compass sensor. In other words, a user may input a control direction for the window using the pointing device.

The control signal CS may be a result of performing an AND operation on a plurality of events, e.g., EVT1 and EVT2. In other words, the event manager 160 generates the control signal CS when receiving both the first event EVT1 generated in the first event generator 120 (e.g., an event generated when one among a plurality of keys arranged in the first event generator 120, i.e., a keyboard is pressed down) and the second event EVT2 generated in the second event generator 140 (e.g., an event generated when the second event generator 140, i.e., a mouse including a plurality of buttons is dragged with one of the buttons pressed and held down) at a time.

The types of window control may include position change, size adjustment, closing, transparency adjustment, and switching to a top window. The type of window control may be determined by a combination of a plurality of events according to predetermined conditions.

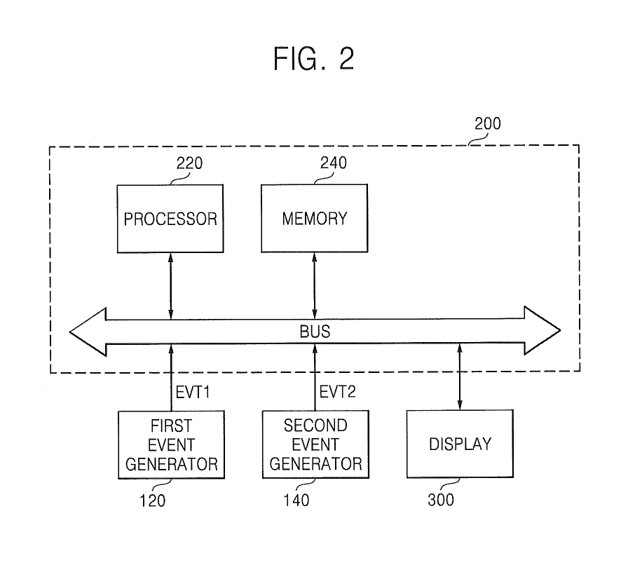

FIG. 2 is a block diagram of a window control system 200 which performs a method of controlling a window displayed on a display according to some embodiments of the inventive subject matter. Referring to FIG. 2, the window control system 200 includes a processor 220 and a memory 240 connected with the processor 220 via a bus. The event manager 160 and the window manager 180 illustrated in FIG. 1 may be included in the processor 220.

The window control system 200 receives the first event EVT1 from the first event generator 120 and the second event EVT2 from the second event generator 140 and generates a control signal for controlling a window displayed on a display 300 based on the first and the second events EVT1 and EVT2.

The operations for controlling the window displayed at the display 300 may be performed using a program that can be executed using the processor 220 and stored in the memory 240.

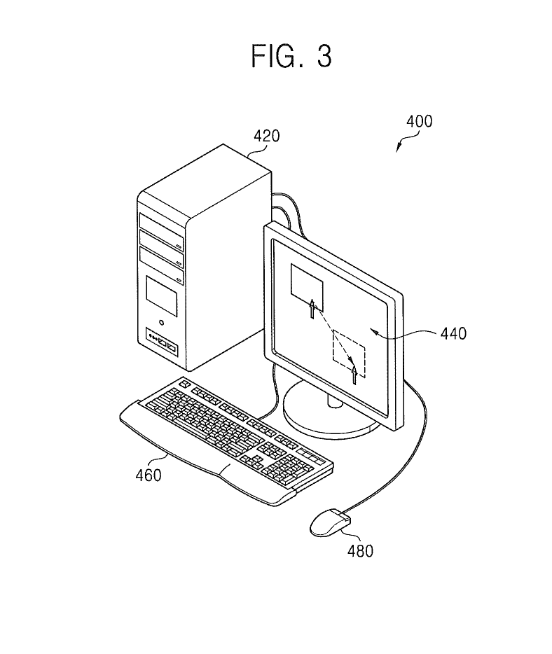

FIG. 3 is a diagram illustrating operations for controlling a window displayed on a display of a computer according to some embodiments of the inventive subject matter. Referring to FIGS. 2 and 3, when the operations are performed in a computer system 400, a host 420 included in the computer system 400 may include the window control system 200 illustrated in FIG. 2.

A user may control a window displayed on a display 440 using a keyboard 460 and a mouse 480. The display 440 may implemented by a light-emitting diode (LED) display, an electroluminescent display (ELD), a plasma display panel (PDP), a liquid crystal display (LCD), an organic LED (OLED) display, or a surface-conduction electron-emitting (SED) display.

When a user puts a mouse pointer at an area in which a window is displayed and then presses and holds one (e.g., a window key) of a plurality of keys arranged in the keyboard 460 and presses down one (e.g., a left or a right button) of a plurality of buttons included in the mouse 480, the window may be switched to a top window.

A user may change the transparency of a window by putting the mouse pointer at an area in which the window is displayed and then pressing and holding down one (e.g., the window key) of the keys arranged in the keyboard 460 and manipulating one (e.g., a scroll wheel) of the buttons included in the mouse 480.

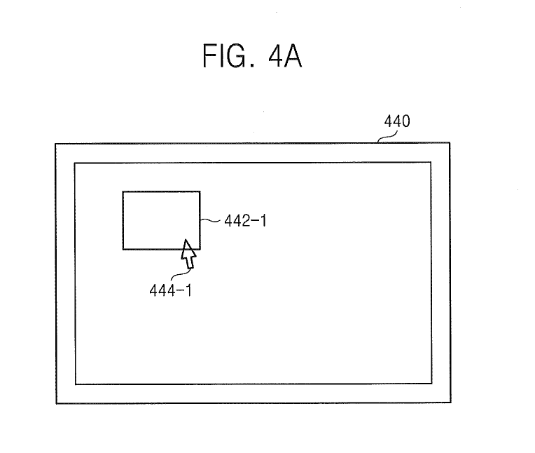

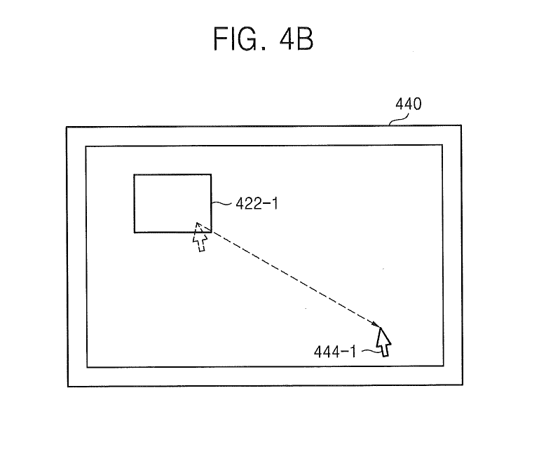

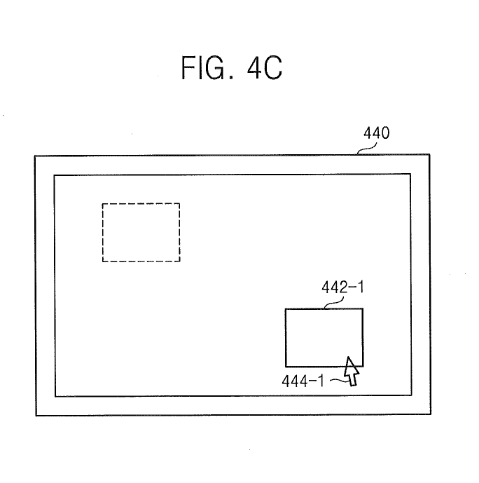

FIGS. 4A through 4C are diagrams for illustrating operations for controlling the position change of a window displayed at the display 440 of the computer system 400 illustrated in FIG. 3 in a method of controlling a window displayed on a display according to some embodiments of the inventive subject matter.

Referring to FIGS. 1 through 4C, when the first event generator 120 is the keyboard 460 including the plurality of keys, the first event EVT1 is generated by pressing down one (e.g., the window key) of the keys. When the second event generator 140 is the mouse 480 including the plurality of buttons, the second event EVT2 is generated by dragging the mouse 480 with one (e.g., the left button) of the buttons pressed and held down.

In other words, while a window 442-1 is being displayed at the display 440, if a user puts a mouse pointer 444-1 at an area in which the window 442-1 is displayed as illustrated in FIG. 4A, then presses down one of the keys in the keyboard 460 (which generates the first event EVT1), and then drags the mouse 480 with one of the buttons in the mouse 480 pressed and held down (which generates the second event EVT2) to move the mouse pointer 444-1 to a wanted position as illustrated in FIG. 4B, the position of the window 442-1 is changed as illustrated in FIG. 4C.

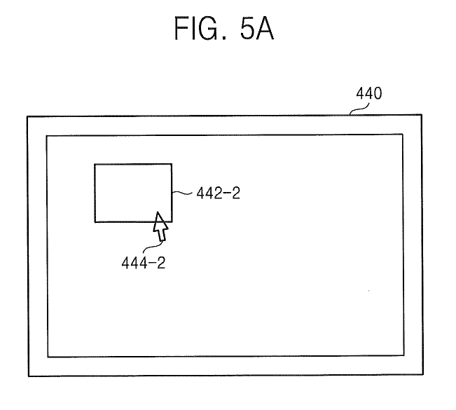

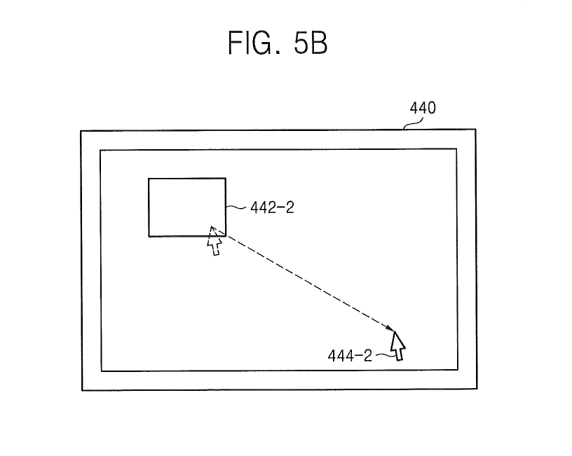

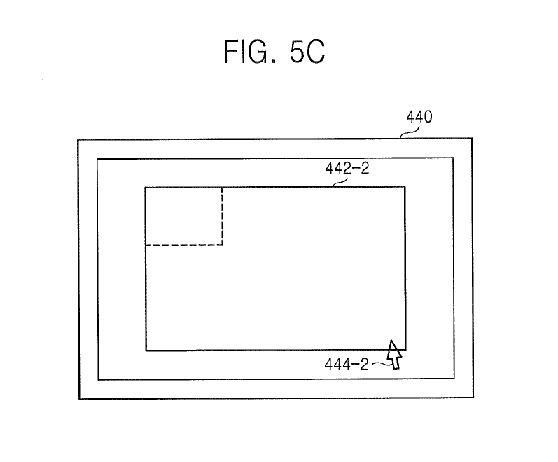

FIGS. 5A through 5C are diagrams for illustrating operations for controlling the size adjustment of a window displayed at the display 440 of the computer system 400 illustrated in FIG. 3 according to further embodiments of the inventive subject matter.

Referring to FIGS. 1 through 3 and FIGS. 5A through 5C, when the first event generator 120 is the keyboard 460 including the plurality of keys, the first event EVT1 is generated by pressing down one (e.g., the window key) of the keys. When the second event generator 140 is the mouse 480 including the plurality of buttons, the second event EVT2 is generated by dragging the mouse 480 with one (e.g., the right button) of the buttons pressed and held down.

In other words, while a window 442-2 is being displayed at the display 440, if a user puts a mouse pointer 444-2 at an area in which the window 442-2 is displayed as illustrated in FIG. 5A, then presses down one of the keys in the keyboard 460 (which generates the first event EVT1), and then drags the mouse 480 with one of the buttons in the mouse 480 pressed and held down (which generates the second event EVT2) to move the mouse pointer 444-2 as much as the user wants to change the size of the window 442-2 as illustrated in FIG. 5B, the size of the window 442-2 is adjusted as illustrated in FIG. 5C.

A direction in which a window is controlled, i.e., a control direction of a window may be determined by the position of a mouse pointer located when the control signal CS is generated, for example, when the control signal CS is activated to a high level. Alternatively, the window manager 180 may control an activated window regardless of the position of the mouse pointer located when the control signal CS is generated.

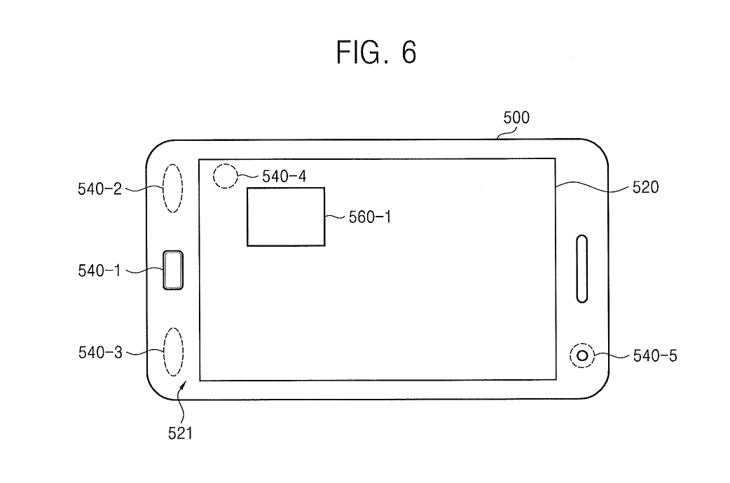

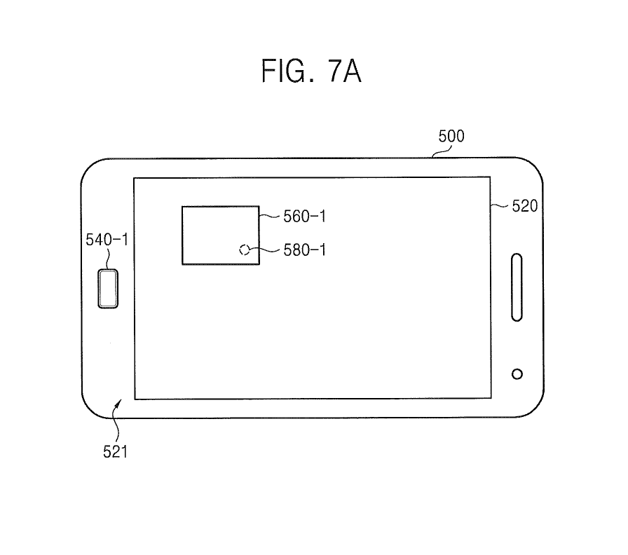

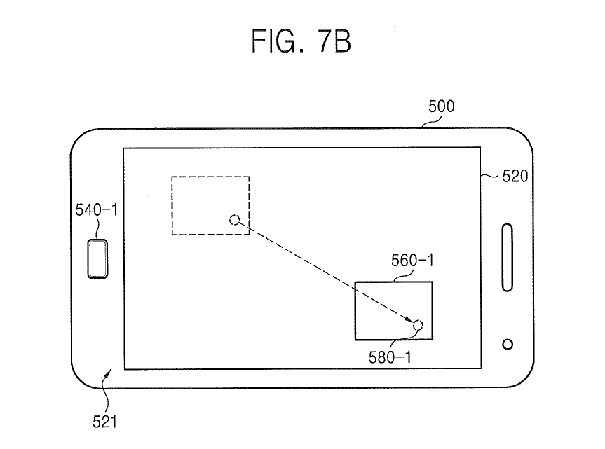

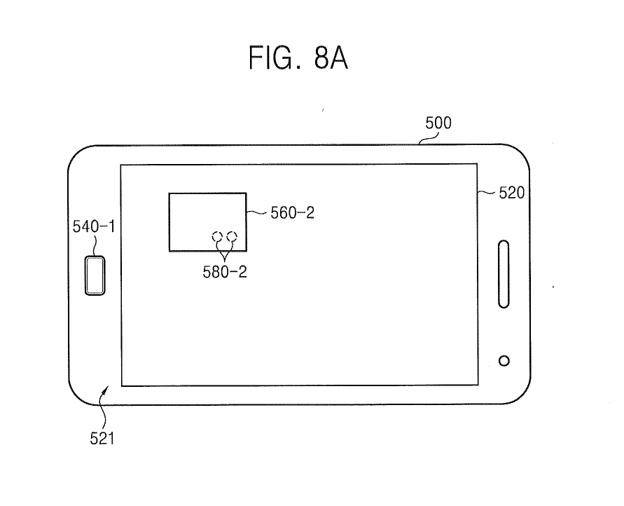

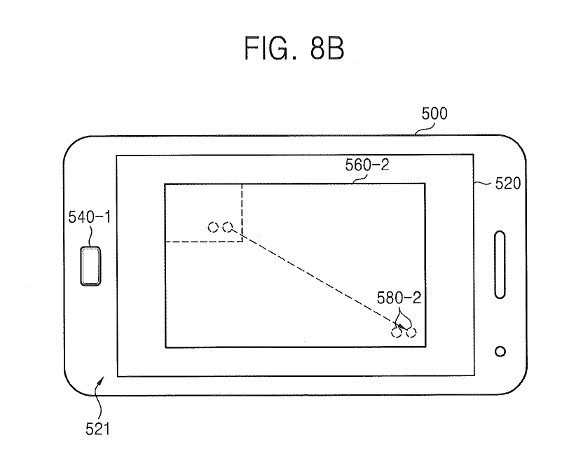

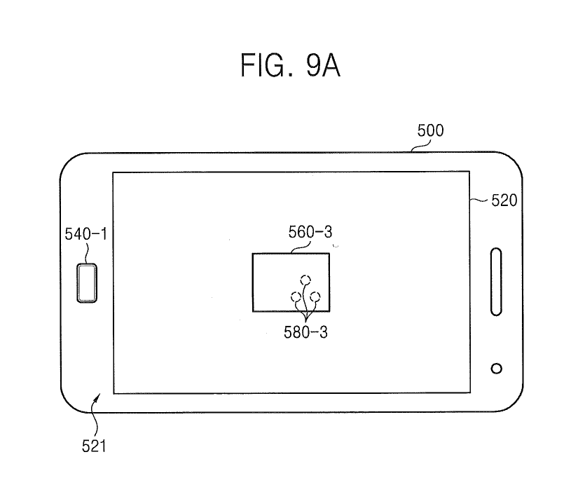

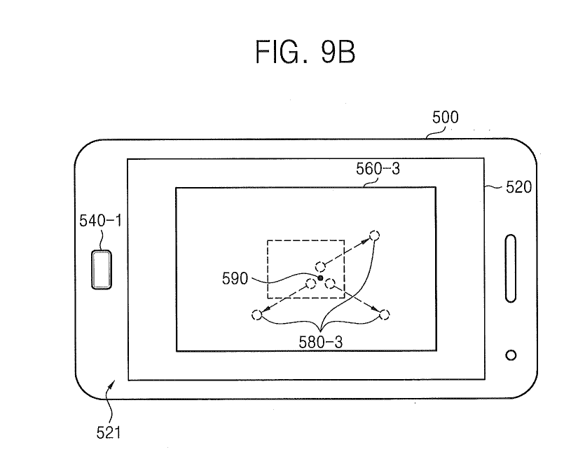

FIG. 6 is a diagram illustrating operations for controlling a window displayed on a display of a mobile device according to some embodiments of the inventive subject matter. FIGS. 7A and 7B are diagrams for illustrating operations for controlling the position change of a window displayed on a display of a mobile device according to further embodiments of the inventive subject matter. FIGS. 8A and 8B are diagrams for illustrating operations for controlling the size adjustment of a window displayed on a display of a mobile device in a method of controlling a window displayed on a display according to further embodiments of the inventive subject matter. FIGS. 9A and 9B are diagrams for illustrating operations for controlling the size adjustment of a window displayed on a display of a mobile device according to yet further embodiments of the inventive subject matter.

Referring to FIGS. 1 and 2 and FIGS. 6 through 9B, the operations for controlling a window displayed on a display may be performed using a mobile device 500 including a touch screen display 520.

When a plurality of buttons 540-1, 540-2 and 540-3 implemented in a non-display area 521 of the mobile device 500 correspond to the first event generator 120, the first event EVT1 may be generated by pressing down one of the buttons 540-1, 540-2 and 540-3. When the touch screen display, i.e., a display area 520 corresponds to the second event generator 140, the second event EVT2 may be generated by touching the display area 520.

The type of window control may be determined by the number of touch points used by a user to touch the display area 520. For instance, the position of a window 560-1 may be changed (FIGS. 7A and 7B) when the number of touch points is one, the size of a window 560-2 may be adjusted (FIGS. 8A and 8B) when the number of touch points is two, and the size of a window 560-3 may be adjusted around a center 590 between touch points (FIGS. 9A and 9B) when the number of the touch points is three.

The number of touch points may correspond to the number of a user's fingers touching the display area 520.

Referring to FIGS, 1, 2, 6, 7A and 7B, the window 560-1 is being displayed at the touch screen display 520 as shown in FIG. 6 or 7A. In this state, while pressing and holding down a button (e.g., the home button 540-1) (which generates the first event EVT1) among the buttons 540-1, 540-2 and 540-3 with one hand, a user puts a finger of the other hand on an area where the window 560-1 is displayed (which generates the second event EVT2) and drags the finger on the touch screen display 520 to a wanted position to move a touch point 580-1 to the wanted position. Then, the position of the window 560-1 is changed to the wanted position as shown in FIG. 7B. Here, the touch point 580-1 may correspond to the user's one finger.

Referring to FIGS, 1, 2, 6, 8A and 8B, the window 560-2 is being displayed at the touch screen display 520 as shown in FIG. 8A. In this state, while pressing and holding down a button (e.g., the home button 540-1) (which generates the first event EVT1) among the buttons 540-1, 540-2 and 540-3 with one hand, a user puts two fingers of the other hand on the window 560-2 in the touch screen display 520 (which generates the second event EVT2) and drags the two finger on the touch screen display 520 to move touch points 580-2 as much as the user wants to change the size of the window 560-2. Then, the size of the window 560-2 is adjusted as shown in FIG. 8B. Here, the touch points 580-2 may correspond to the user's two fingers.

Referring to FIGS, 6, 9A and 9B, the window 560-3 is being displayed at the touch screen display 520. In this state, while pressing and holding down a button (e.g., the home button 540-1) (which generates the first event EVT1) among the buttons 540-1, 540-2 and 540-3 with one hand, a user puts three fingers of the other hand on the window 560-3 in the touch screen display 520 (which generates the second event EVT2) and drags the three fingers outward on the touch screen display 520 to move out touch points 580-3. Then, the window 560-3 is expanded out around the center 590 between the touch points 580-3 so that the size of the window 560-3 is adjusted as shown in FIG. 9B. Alternatively, the first event EVT1 may be generated when a predetermined portion 540-4 of the display area 520 is touched as illustrated in FIG. 6.

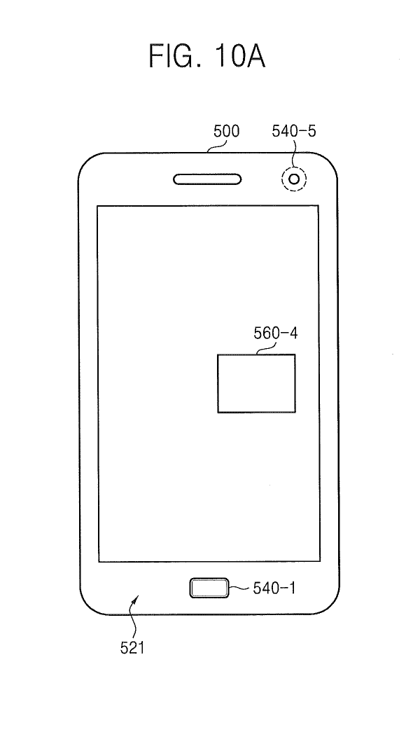

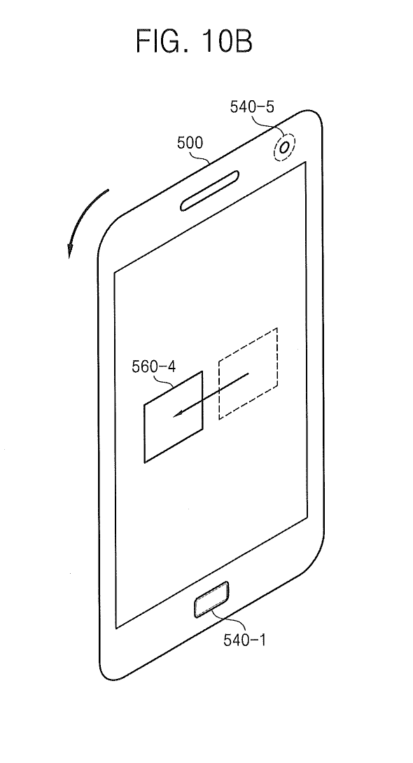

FIGS. 10A and 10B are diagrams for illustrating operations for controlling the position change of a window displayed on a display of the mobile device 500 according to still further embodiments of the inventive subject matter. Referring to FIGS. 1, 2, 10A and 10B, when the first event generator 120 is the button 540-1 implemented in the non-display area 521 of the mobile device 500, the first event EVT1 is generated by pressing the button 540-1. When the second event generator 140 is an acceleration sensor (not shown) of the mobile device 500, the second event EVT2 is generated based on a sensed value of the acceleration sensor.

For instance, while a window 560-4 is displayed at the display 520 as shown in FIG. 10A, if a user presses and holds down the button 540-1 in the non-display area 521 (which generates the first event EVT1) and tilts the mobile device 500 in a predetermined direction (which generates the second event EVT2), the acceleration sensor senses the tilt of the mobile device 500 and the window 560-4 is controlled (e.g., the position of the window 560-4 is changed or the size thereof is adjusted) based on a sensed value as shown in FIG. 10B.

When the operations for controlling a window displayed on a display is performed in the mobile device 500, the first event generator 120 may be a proximity sensor, an ambient light sensor 540-5, a camera or an audio input device in further embodiments. When the first event generator 120 illustrated in FIG. 1 or 2 is the ambient light sensor 540-5 of the mobile device 500, the first event EVT1 may be generated by covering the ambient light sensor 540-5.

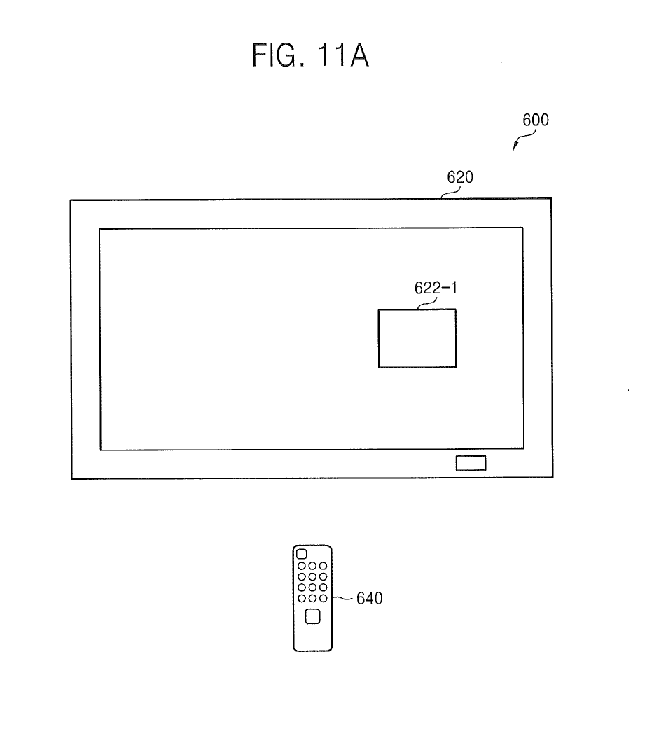

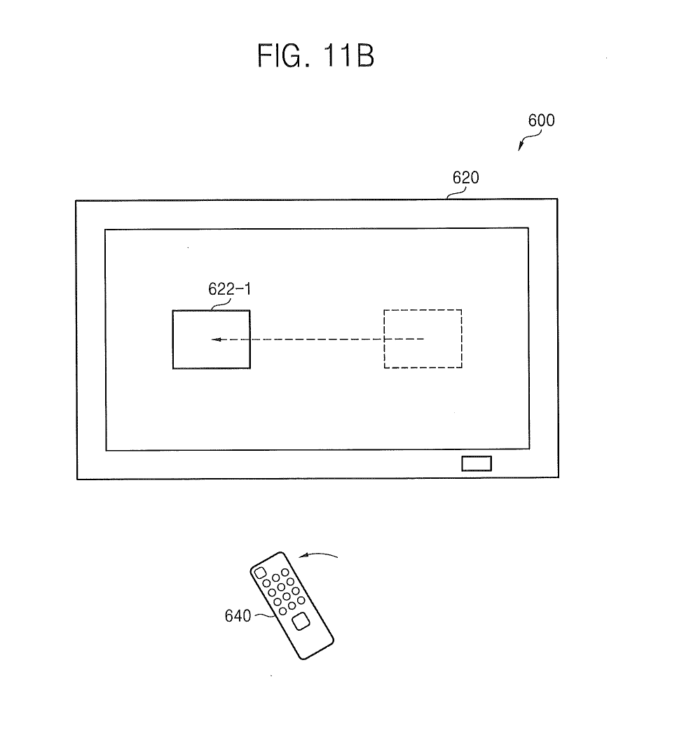

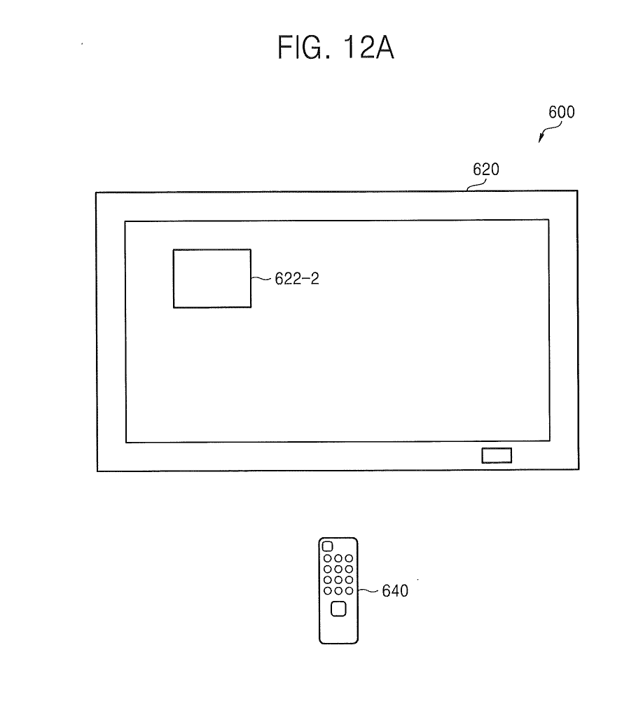

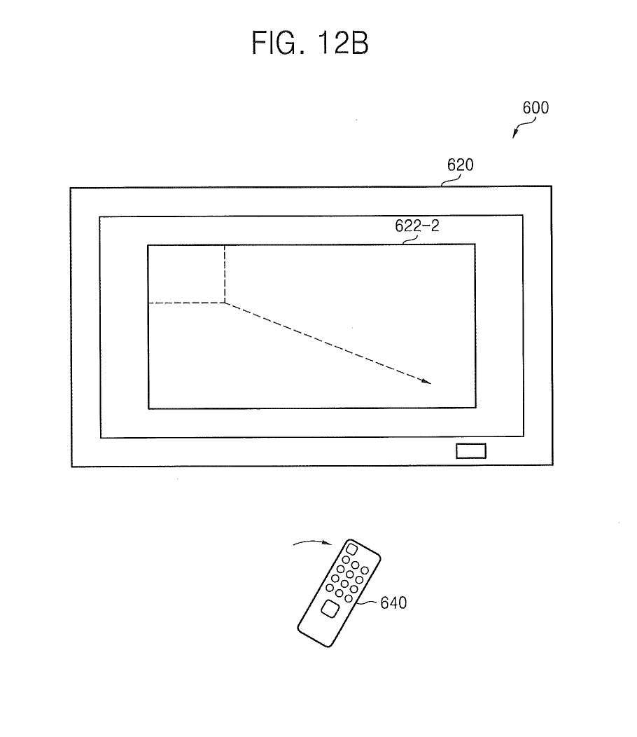

FIGS. 11A and 11B are diagrams for illustrating operations for controlling the position change of a window displayed on a display of a television (TV) according to further embodiments of the inventive subject matter. FIGS. 12A and 12B are diagrams for illustrating operations for controlling the size adjustment of a window displayed on a display of a TV in a method of controlling a window displayed on a display according to further embodiments of the inventive subject matter.

Referring to FIGS. 1 and 2 and FIGS. 11A through 12B, the operations for controlling a window displayed on a display is performed in a TV system 600. When the first event generator 120 is a remote controller 640 including a plurality of buttons, the first event EVT1 is generated by pressing one of the buttons. When the second event generator 140 is an acceleration sensor (not shown) of the remote controller 640, the second event EVT2 is generated based on a sensed value of the acceleration sensor.

Referring to FIGS. 1, 2, 11A and 11B, while a window 622-1 is being displayed at a TV display 620 as shown in FIG. 11A, if a user presses and holds down one of the buttons in the remote controller 640 (which generates the first event EVT1) and tilts the remote controller 640 (which generates the second event EVT2), the acceleration sensor senses the tilt of the remote controller 640 and the position of the window 622-1 is changed based on a sensed value as shown in FIG. 11B.

Referring to FIGS. 1, 2, 12A and 12B, while a window 622-2 is being displayed at the TV display 620 as shown in FIG. 12A, if a user presses and holds down one of the buttons in the remote controller 640 (which generates the first event EVT1) and tilts the remote controller 640 (which generates the second event EVT2), the acceleration sensor senses the tilt of the remote controller 640 and the size of the window 622-2 is adjusted based on a sensed value as shown in FIG. 12B.

Referring to FIGS. 11A through 12B, the position and the size of a window displayed at the TV display 620 are controlled by tilting the remote controller 640 to the left or the right or up or down. The control direction of a window may be determined by the type of a button pressed by a user among the buttons in the remote controller 640.

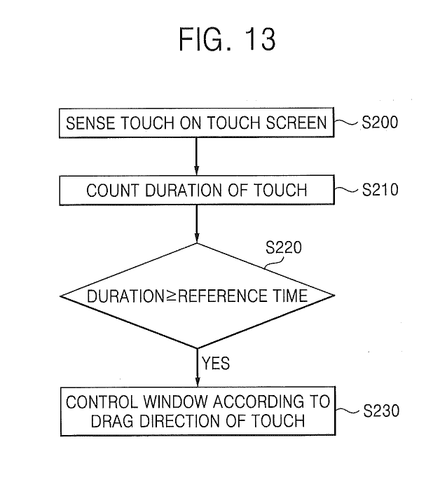

FIG. 13 is a flowchart of operations for controlling a window displayed on a display according to some embodiments of the inventive subject matter. Referring to FIGS. 1 and 13, the event manager 160 senses a touch on a touch screen in operation S200. A counter counts a duration of the touch in operation S210. The duration is compared with a reference time in operation S220. When the duration is equal to or greater than the reference time, the window manager 180 controls the position and/or the size of the window according to a drag direction of the touch in operation S230. In further embodiments, the type of control may be one of position change, size adjustment, and/or transparency adjustment with respect to a window.

The type of control may be determined by the number of touch points. For instance, the type of control may be the position change when the number of touch points is one and the type of control may be the size adjustment when the number of touch points is two.

In some embodiments, the type of control may be determined by the duration of a touch. For instance, the type of control may be the position change when the duration of a touch is equal to or greater than a first reference time and less than a second reference time. The type of control may be the size adjustment when the duration of a touch is equal to or greater than the second reference time.

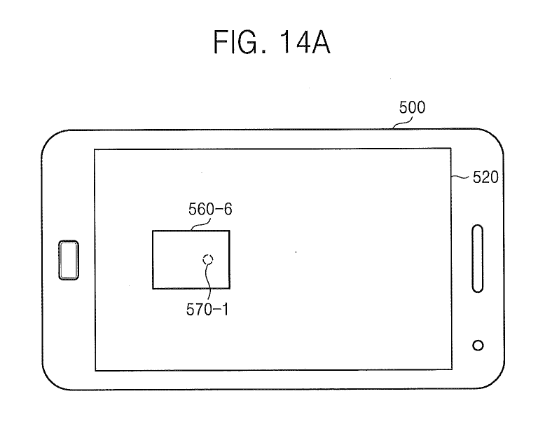

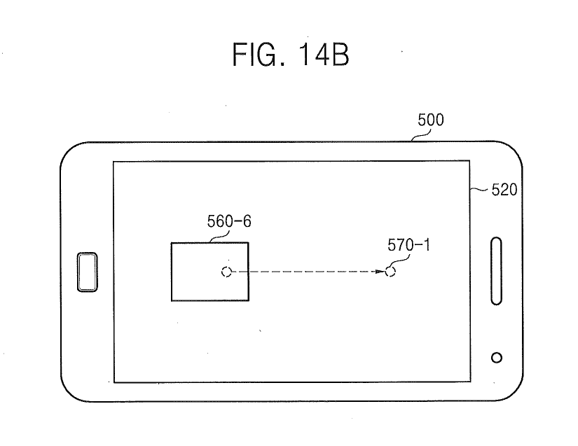

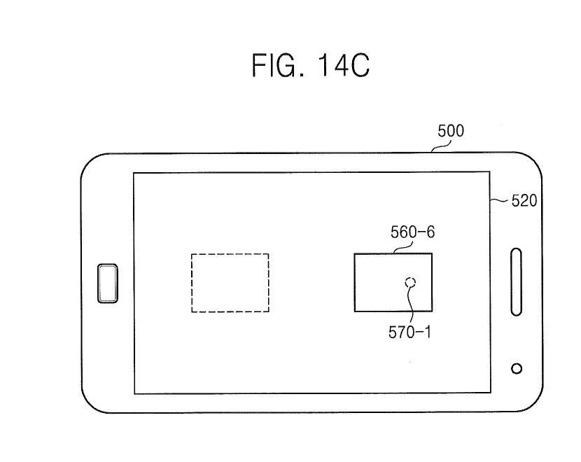

FIGS. 14A through 14C are diagrams for illustrating operations for controlling the position change of a window displayed at the display 520 of the mobile device 500 according to further embodiments of the inventive subject matter.

Referring to FIGS. 1 and 2 and FIGS. 14A through 14C, the operations are performed in the mobile device 500 including a touch screen. When a user touches a window 560-6 displayed in the display area 520 at a touch point 570-1 for a time equal to or longer than a reference time (FIG. 14A) and then drags the touch point 570-1 to a position to which the user wants to move the window 560-6 (FIG. 14B), the position of the window 560-6 is changed (FIG. 14C).

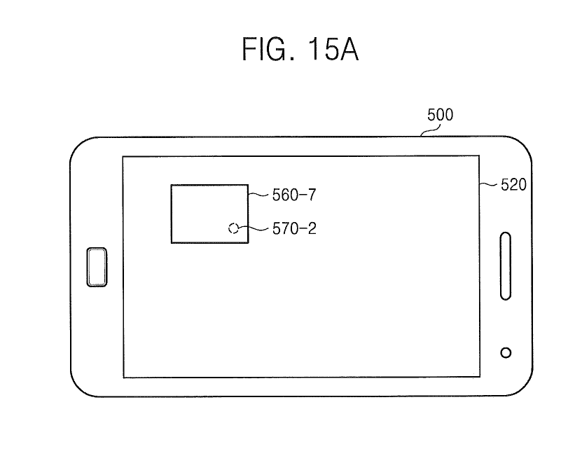

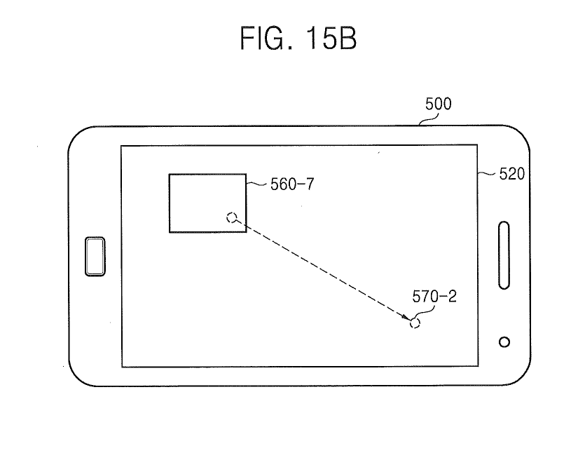

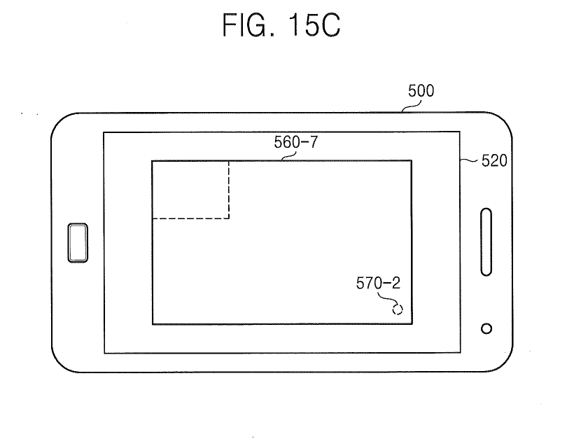

FIGS. 15A through 15C are diagrams for illustrating operations for controlling the size adjustment of a window displayed at the display 520 of the mobile device 500 according to further embodiments of the inventive subject matter. Referring to FIGS. 1 and 2 and FIGS. 15A through 15C, the operations are performed in the mobile device 500 including a touch screen. When a user touches a window 560-7 displayed in the display area 520 at a touch point 570-2 for a time equal to or longer than a reference time (FIG. 15A) and then drags the touch point 570-2 as much as the user wants to change the size of the window 560-7 (FIG. 15B), the size of the window 560-7 is adjusted (FIG. 15C).

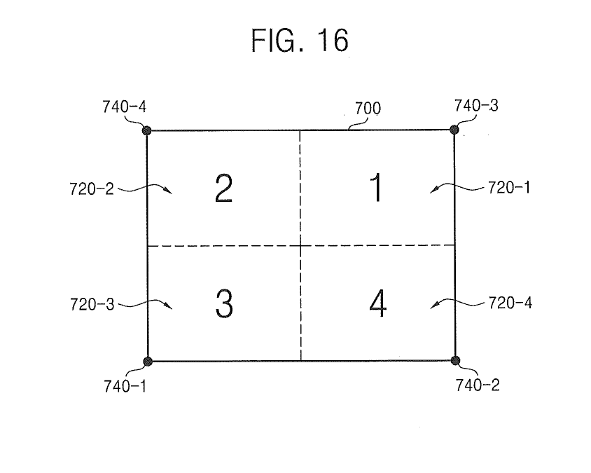

FIG. 16 is a diagram for explaining directions in which the size of a window is adjusted in a method of controlling a window displayed on a display 700 according to further embodiments of the inventive subject matter. Referring to FIGS. 1, 2, and 16, the control direction of a window on the display 700 may be determined by the position of a mouse pointer or a touch point when the control signal CS is generated.

When the display 700 is divided into four sections 720-1, 720-2, 720-3 and 720-4, a vertex diagonally facing a section in which the mouse pointer or the touch point is located when the control signal CS is generated may be a reference point for the control direction of a window.

For instance, when the control signal CS is generated if the mouse pointer or the touch point is located in the first section 720-1, a vertex 740-1 of the third section 720-3 is fixed. If the mouse pointer or the touch point is located in the second section 720-2, a vertex 740-2 of the fourth section 720-4 is fixed. If the mouse pointer or the touch point is located in the third section 720-3, a vertex 740-3 of the first section 720-1 is fixed. If the mouse pointer or the touch point is located in the fourth section 720-4, a vertex 740-4 of the second section 720-2 is fixed.

For purposes of clarity of the description, a user's finger corresponds to a touch point in the above-described embodiments, but the inventive subject matter is not restricted to those embodiments.

In operations for controlling a window displayed on a display of a computer, the window can be controlled without putting a mouse pointer to a particular position, so that a user can conveniently control the window in a large display. In addition, in a method of controlling a window displayed on a display of a smart TV, a digital information display (DID) system, or a mobile device, a user can easily control the window using various input devices, so that the user's convenience may be improved in controlling the window.

While the inventive subject matter has been particularly shown and described with reference to exemplary embodiments thereof, it will be understood by those of ordinary skill in the art that various changes in forms and details may be made therein without departing from the spirit and scope of the inventive subject matter as defined by the following claims.

What is claimed is:

1. A method of operating an electronic device comprising a display, the method comprising:
detecting first and second events generated by respective ones of first and second event generators; and
executing a particular window transformation on the display based on the first event in a direction identified by the second event.

2. The method of claim 1, wherein a type of the window transformation comprises a position change or a size adjustment.

3. The method of claim 1, wherein the first event generator is a keyboard, wherein the first event is generated by pressing down a key of the keyboard, wherein the second event generator is a mouse, and wherein the second event is generated by dragging the mouse.

4. The method of claim 3, wherein a control direction of the window is determined by a position of a mouse pointer.

5. The method of claim 3, wherein the window is an activated window regardless of a position of a mouse pointer located when a button of the mouse and the key of the keyboard are pressed down.

6. The method of claim 1, wherein the first event generator is one of a plurality of buttons implemented in a non-display area of the mobile device, wherein the first event is generated by pressing down the one of the buttons, wherein the second event generator is a display area of a mobile device and wherein the second event is generated by touching the display area.

7. The method of claim 6, wherein a type of the window transformation is identified based on a number of touch points made by a user on the display area.

8. The method of claim 1, when the first event generator is one of a plurality of buttons implemented in a non-display area of a mobile device, wherein the first event is generated by pressing down the one of the buttons, wherein the second event generator is an acceleration sensor of the mobile device, and wherein the second event is generated responsive to an input to the acceleration sensor.

9. The method of claim 1, wherein the first event generator is an ambient light sensor of a mobile device, wherein the first event is generated by covering the ambient light sensor, wherein the second event generator is an acceleration sensor of the mobile device, and wherein the second event is generated responsive to an input to the acceleration sensor.

10. The method of claim 1, when the first event generator is one of a plurality of buttons of a remote control device, wherein the first event is generated by pressing the one of the buttons, wherein the second event generator is an acceleration sensor of the remote control device and wherein the second event is generated responsive to an input to the acceleration sensor.

11. A method of operating an electronic device comprising a display, the method comprising:
sensing a touch on a touch screen associated with the display;
comparing a duration of the touch with a reference time; and
controlling a window transformation according to a drag direction of the touch when the duration meets a predetermined criterion with respect to the reference time.

12. The method of claim 11, wherein a type of the window transformation comprises a position change or a size adjustment of the window.

13. The method of claim 11, wherein a type of the window transformation is determined based on a number of points of the sensed touch.

14. The method of claim 11, wherein a type of the window transformation is determined based on the duration of the touch.

15. A method of controlling a window on a display of an electronic device, the method comprising:
accepting a first user input of a first type;
identifying a window transformation operation based on the first user input;
accepting a second user input of a second type; and
performing the identified window transformation operation in a direction indicated by the second user input.

16. The method of claim 15, wherein the window transformation operation comprises a window repositioning or a window resizing operation.

17. The method of claim 15, wherein the first type comprises a button actuation, a mouse selection or a touch screen selection.

18. The method of claim 15, wherein the second type comprises an acceleration sensor input, a mouse movement or touch screen swipe.

19. The method of claim 15, wherein the electronic device comprises a handheld mobile device, wherein the first user input comprises activation of a button on the mobile device and wherein the second user input comprises an input to an accelerometer of the mobile device or an input to a touchscreen of the mobile device.

20. The method of claim 15, wherein the electronic device comprises a television, wherein the first user input comprises actuation of a button on a remote control device and wherein the second user input comprises an input to an accelerometer of the remote control device.
